(19) United States
(12) Patent Application Publication
(10) Pub. No.: US 2015/0100563 A1
(43) Pub. Date: Apr. 9, 2015

(54) METHOD FOR RETAINING SEARCH ENGINE OPTIMIZATION IN A TRANSFERRED WEBSITE

(71) Applicant: Go Daddy Operating Company, LLC, Scottsdale, AZ (US)

(72) Inventor: Guy Ellis, Scottsdale, AZ (US)

(21) Appl. No.: 14/049,928

(22) Filed: Oct. 9, 2013

(51) Int. Cl. G06F 17/30

(52) U.S. Cl. CPC G06F 17/30864
USPC 707/709; 707/782; 707/756; 707/748; 707/711

(57) ABSTRACT

Systems and methods for implementing changes to a website without losing the indexing status and accumulated SEO metrics for web pages of the website may include creating a page mapping table that associates old web page URLs with new web page URLs. Old web page URLs may be obtained by crawling the website or by searching the indexing cache of one or more search engines. The old web page URLs are saved as source paths in the table. New web page URLs may be manually associated with the source paths as destination paths in the table, or the destination paths maybe automatically obtained. A web server or a reverse proxy server uses the page mapping table to send 301 redirects to devices that request the old web pages. Usage data of the new web page may be collected and analyzed to determine if an automatically identified destination path is correct.

### CROSS-REFERENCE TO RELATED APPLICATIONS

Not applicable.

### FIELD OF THE INVENTION

The present invention generally relates to website communication and management, and, more specifically, to systems and methods for efficiently and effectively retaining placement of a website in Internet search results when the website is transferred between website hosting providers.

### BACKGROUND OF THE INVENTION

The Internet comprises a vast number of computers and computer networks that are interconnected through communication links. The interconnected computers exchange information using various services. In particular, a server computer system, referred to herein as a web server, may connect through the Internet to a remote client computer system and may send, to the remote client computer system upon request, one or more websites containing one or more graphical and textual web pages of information. The information on web pages is in the form of programmed source code that the browser interprets to determine what to display on the requesting device. The source code may include document formats, objects, parameters, positioning instructions, and other code that is defined in one or more web programming or markup languages. One web programming language is HyperText Markup Language (HTML), and all web pages use it to some extent. HTML uses text indicators called tags to provide interpretation instructions to the browser. The tags specify the composition of design elements such as text, images, shapes, hyperlinks to other web pages, programming objects such as JAVA applets, form fields, tables, and other elements. The web page can be formatted for proper display on computer systems with widely varying display parameters, due to differences in screen size, resolution, processing power, and maximum download speeds.

Websites, unless extremely large and complex or have unusual traffic demands, typically reside on a single server and are prepared and maintained by a single individual or entity. Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting service providers typically provide the hardware, software, and electronic communication means necessary to connect multiple websites to the Internet. A single hosting service provider may literally host thousands of websites on one or more hosting web servers.

To view a website, a request is made to the web server by visiting the website's address. Upon receipt, the requesting device can display the web pages. The request and display of the websites are typically conducted using a browser. A browser is a special-purpose application program that effects the requesting of web pages and the displaying of web pages. Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A uniform resources locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. The process for registering a domain name with .com, .net, .org, and some other TLDs allows an Internet user to use an ICANN-accredited registrar to register their domain name. Domain names are typically registered for a period of one to ten years with first rights to continually re-register the domain name.

The process of translating user-friendly domain names to IP Addresses is called Name Resolution. The domain name system (DNS) is the world's largest distributed computing system that enables access to any resource in the Internet by performing name resolution. A DNS name resolution is the first step in the majority of Internet transactions. The DNS is a client-server system that provides this name resolution service through a family of servers. In order for the domain name to resolve to the IP Address where the web server makes the website available, the web server may need to maintain several types of DNS server records, including the Address (A) record, Name Server (NS) record, and Mail Exchange (MX) record, among others. The DNS records contain information about the website location and resolution instructions to be interpreted by the DNS server. When a website is transferred between locations, such as if the web server is physically or electronically relocated or the hosting provider for the website is changed, these DNS records must be updated to resolve the domain name to the new location.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other. Competition between business has increased, as more businesses can access the same customers electronically. That is, a local business does not only compete with its “brick-and-mortar” physical neighbors, but also with businesses in distant locations and businesses that interact with customers purely online.

Customers frequently use Internet search engines, such as GOOGLE, BING, YAHOO, or BAIDU, to find businesses that provide the goods or services sought. Internet search engines create indexes of websites based on the contents of the websites. A searching customer enters keywords relevant to the goods or services into the search engine and receives search engine results pages (SERPs) displaying websites or web pages from the index in order of relevance to the entered keywords. In order to attract customers online, a business benefits from its website placing highly on SERPs for keywords that are relevant to its business. To improve its placement, a business may engage in search engine optimization (SEO) of its website. SEO may include modifying the code of web pages in the business's website to include strategically selected keywords in particular parts of the web pages. The optimized web pages must be exposed to the search engine's indexing activities for the SEO to be effective. If a web page is properly indexed, its prominence (i.e., its placement within the SERPs) can continually improve through scoring metrics, such as GOOGLE Page Rank, performed by the search engine.

Unfortunately, many changes to a website's structure can inhibit the search engines' indexing activities. For example, changing a URL for a web page or moving the website in a way that requires DNS record changes will separate the pages of the website from the accrued scoring information for one or more of the web pages. As a result, website owners are hesitant to make major changes to their website, such as transferring their website to a new hosting provider, because they fear they will lose earned prominence of their web pages.

### BRIEF DESCRIPTION OF THE DRAWINGS

FIG. 1 is schematic diagram of a first embodiment of a system and associated operating environment in accordance with the present disclosure.

FIG. 2 is a flow diagram of a first embodiment of a method for creating a page mapping table in accordance with the present disclosure.

FIG. 3 is a flow diagram of a second embodiment of a method for creating a page mapping table in accordance with the present disclosure.

FIG. 4 is a flow diagram of a first embodiment of a method for handling URL requests in accordance with the present disclosure.

FIGS. 5 and 6 are schematic diagrams of a system implementing a page saver module in accordance with the present disclosure.

FIG. 7 is a schematic diagram of a second embodiment of a system and associated operating environment in accordance with the present disclosure.

FIG. 8 is a schematic diagram of a third embodiment of a system and associated operating environment in accordance with the present disclosure.

FIG. 9 is a flow diagram of a third embodiment of a method for creating a page mapping table in accordance with the present disclosure.

FIG. 10 is a schematic diagram of a fourth embodiment of a system and associated operating environment in accordance with the present disclosure.

### DETAILED DESCRIPTION OF THE PREFERRED EMBODIMENT

The present invention overcomes the aforementioned drawbacks by providing a system and method for implementing changes to a website without losing the indexing status and accumulated SEO metrics of each of the web pages. The web server tasked with serving the website to requesting devices, which is also known as a hosting provider and may be the new web server in a hosting-transfer situation as described below, may perform one or more algorithms for the website changes. Alternatively, the web server may assign the changes to a related computer system, such as another web server, collection of web or other servers, a dedicated data processing computer, or another computer capable of performing the creation algorithms. Alternatively, a standalone program may be delivered to and installed on a personal computing device, such as the user's desktop computer or mobile device, and the standalone program may be configured to cause the personal computing device to perform the algorithms. For clarity of explanation, and not to limit the implementation of the present methods, the methods are described below as being performed by a web server that serves the web page to requesting devices.

In one implementation, a method in accordance with the present disclosure includes: receiving, on a server computer and from a requestor in communication with the server computer over a computer network, a request for a first web page hosted at a source URL; determining, by the server computer, a destination URL from one or more of the source URL and the first web page; and redirecting, by the server computer, the requestor to the destination URL. In another implementation, a method in accordance with the present disclosure includes: obtaining, by a server computer, one or more source URLs each corresponding to one of a plurality of first web pages of a first website; storing, by the server computer, one or more of the source URLs as source paths in a page mapping table that associates each of the source paths with a destination path; for each source path, determining if one of a plurality of second web pages should be associated with the source path and, if one of the second web pages should be associated with the source path, storing the URL of the second web page as the destination path associated with the source path; receiving, on the server computer and from a requestor, a request for one of the first web pages, the request comprising the source URL corresponding to the requested first web page; determining, by the server computer, a destination URL by identifying the source path in which the source URL of the request is stored, and retrieving, as the destination URL, the URL stored in the destination path associated with the identified source path; and redirecting, by the server computer, the requestor to the destination URL. In yet another implementation, a system in accordance with the present invention includes a processor configured to: obtain a source URL for a first web page of a first website; store the source URL as a source path in a page mapping table that associates each of a plurality of source paths with a destination path; match the first web page to a second web page of a second website; and store, in the destination path associated with the source path that contains the source URL, the URL of the second web page.

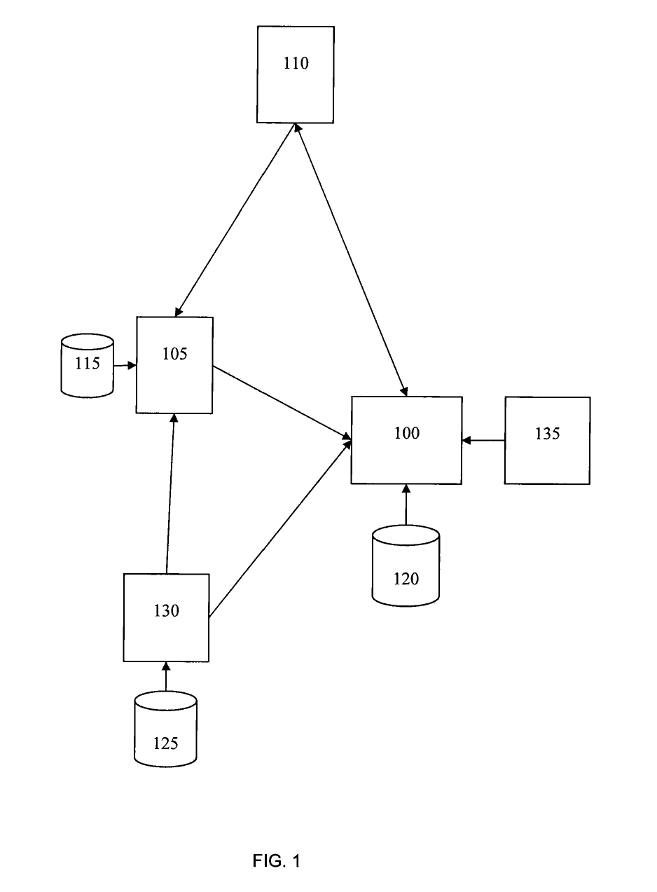

Referring to FIG. 1, a web server 100 may be configured to communicate over the Internet with one or more requesting devices 110 in order to serve requested website content to the requesting device 110. The requesting devices 110 may request the website content using any electronic communication medium, communication protocol, and computer software suitable for transmission of data over the Internet. Examples include, respectively and without limitation: a wired connection, WiFi or other wireless network, cellular network, or satellite network; Transmission Control Protocol and Internet Protocol (TCP/IP), Global System for mobile Communications (GSM) protocols, code division multiple access (CDMA) protocols, and Long Term Evolution (LTE) mobile phone protocols; and web browsers such as MICROSOFT INTERNET EXPLORER, MOZILLA FIREFOX, and APPLE SAFARI. The web server 100 can store or access the website via a website data store 120 that contains some or all of the website and web page source code and other resources needed to serve the website to requesting devices 110. In the present disclosure, therefore, the term website refers to any web property communicable via the Internet, such as websites, mobile websites, web pages within a larger website (e.g. profile pages on a social networking website), vertical information portals, distributed applications, and other organized data sources accessible by any device that may request data from a storage device (e.g., a client device in a client-server architecture), via a wired or wireless network connection, including, but not limited to, a desktop computer, mobile computer, telephone, or other wireless mobile device.

The website data store 120, and other data stores described below, may be any repository of information that is or can be made freely or securely accessible by the web server 100. Suitable data stores include, without limitation: databases or database systems, which may be a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future; file systems; and other electronic files.

The requesting device 110 may request website content when a user enters a URL for the website in the requesting device's 110 browser. The browser then uses the requesting device's 110 communication protocols to access a DNS server 105. The DNS server 105 stores DNS records for the website in a name resolution database 115. The DNS server 105 uses the DNS records to resolve the URL to an IP address for the web server 100 and directs the browser of the requesting device 110 to that IP address. Similarly, as is known in the art, a search engine 130 can access the DNS server 105 to obtain the resolution of the website's domain name to the IP address for the web server 100, and can then index the website in order to include the website in the search engine's 130 SERPs. Indexing the website can include storing information about the website in an index data store 125. The stored information can include website content that the search engine interprets, in light of information stored for other indexed website, to determine a suitable ordering of search results in the SERPs. The content in the index data store 125 therefore may be a primary factor in determining the website's prominence on SERPs for keywords that are relevant to the website. The indexed content typically includes the URLs for some or all of the web pages in the website. As stored, the URL can be a complete URL (e.g. “http://www.website.com/home/example_page.html” or the resolved equivalent “http://123.45.678/home/example_page.html”) or a truncated URL with one or more parent directories implied (e.g. “home/example_page.html” or “example_page.html”) as is known in the art.

An interface module 135 may be configured to electronically access the web server 100 in order to modify the website or to perform page remapping as described below. The interface module 135 may be a web page, web, mobile, or other Internet application, application programming interface (“API”), or a standalone terminal or other computing device. A website owner or his authorized agent (hereinafter “owner”) can use any suitable secured or unsecured means to activate the interface module 135 and access and modify his website or one or more of its configuration files.

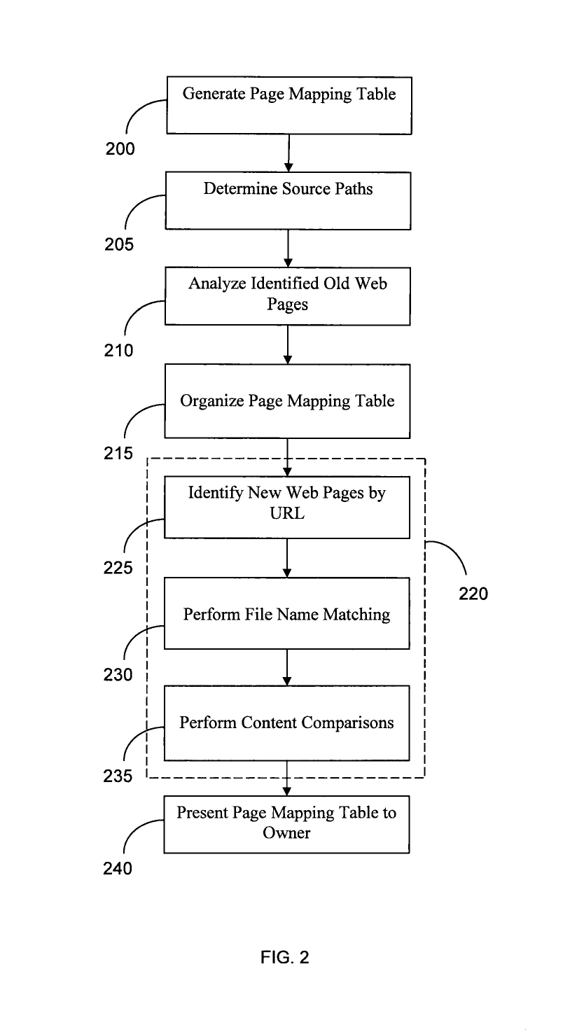

FIG. 2 illustrates an embodiment of a method of using the system of FIG. 1 to maintain the indexing status and protect the SEO metrics of the web pages in the website when web page names are modified. Prior to the owner or web server 100 implementing the method of FIG. 2, several typical internet processes have taken place. The owner created a previous (referred to herein as “first” or “old”) version of the website, uploaded it for storage in the website data store 120, and gave the web server 100 permission to access the website for hosting it at an IP address and/or providing other services. DNS records may have been created and stored in the DNS record database 115 so that the website can be located at a registered domain name, although in this embodiment DNS resolution is optional. One or more search engines 130 indexed the old version of the website once it became available online, and one or more of the web pages have developed valuable SEO metrics through the search engine's 130 indexing and, potentially, other Internet traffic data recorded by the search engine 130. The owner then created a new (referred to herein as “second” or “new”) version of the website that includes changes to the file names of one or more web pages, relocation of content from one web page to another, and/or addition or deletion of web pages. As a result, the search engine's 130 index references to the website's web pages are stale: one or more index references may identify a web page that no longer exists or no longer includes the content that made it previously relevant to particular search terms.

Without performing the method of FIG. 2 or another method according to this disclosure, the indexing status and SEO metrics of the website and any of the modified or new web pages therein are in jeopardy. The search engine 130 will receive access errors when attempting to use its stale references. For example, if an indexed web page no longer exists at its indexed URL, the search engine 130 will receive a HTTP 404 “Not Found” error when it attempts to visit the page. Each access error can negatively impact one or more SEO metrics, reducing the web pages' prominence in SERPs. Eventually, the search engine 130 will remove the referenced web pages from its index entirely.

To prevent the loss of indexing status, at step 200 a page mapping table is generated by the web server 100 or by the interface module 135 itself, and may be stored in the website data store 120 to be accessed by the web server 100 when serving the website. One embodiment of the page mapping table, illustrated as TABLE 1 below, includes columns for the source path and destination path for each web page in the table. The page mapping table may further include a column for indicating the HTTP status code that is generated when a requesting device 110 or search engine 130 requests the source path URL. The page mapping table may further include columns for conveying indexing status and one or more SEO metrics. For example, columns may be included to indicate whether one or more particular search engines 130 have indexed the web page. A column may be provided to convey the GOOGLE Page Rank or another indicator of SERP prominence. Each row of the page mapping table corresponds to a web page of the website. The table may include all of the web pages in the website, or a subset thereof. In one embodiment, the table may include only the web pages that have changed (i.e., have been modified, deleted, or added) between the old and new versions of the website. The source path may be the full or truncated URL of the web page in the old version of the website. The source path may be entered manually by the owner or another entity, or the source paths for the web pages may be automatically retrieved by the web server 100 and pre-populated within the table.

| | Destination | HTTP | GOOGLE | GOOGLE |
|---|---|---|---|---|
| Source Path | Path | Code | Index | Page Rank |
| /index.php?page=home | /index.html | 301 | Yes | 5.5 |
| /about.html | | 200 | Yes | 2 |
| /store.php?product=1 | /store/1 | 404 | Yes | 0 |

In one embodiment, at step 205 the web server 100 may “crawl” the old version of the website using any suitable methodology to determine the source paths of the web pages. Additionally or alternatively, the web server 100 may access the index of one or more search engines 130 to identify the web pages of the website that have been indexed by that search engine 130. For example, a “site:mydomain.com” search may be performed on GOOGLE to obtain one or more SERPs that list all of the web pages on mydomain.com that GOOGLE has indexed. The web server 100 may add the source paths of all or a subset of the web pages that have been indexed to the page mapping table. In one embodiment of such a subset, the web server 100 may determine from the set of indexed web pages which source paths would generate a 404 error if requested from the new website, and may add those web pages to the subset. The web server 100 may also, at step 210, analyze the identified web pages by retrieving data for other columns in the page mapping table. The data retrieved at step 210 may further include data that is not displayed in the table but may be used to organize the table for display in the interface module 135. The retrieved data may include SEO metrics such as GOOGLE Page Rank or SEOMOZ Page Authority, information from web page meta tags, web page titles, and other web page data that may facilitate page mapping.

At step 215, the web server 100 may organize the table for presentation to the owner. Organizing the table may include sorting the rows of web pages to improve the presentation of the table to the owner. In one embodiment, the table may be sorted in descending order of the GOOGLE Page Rank obtained at step 210. This allows the owner to attend to the page mapping of the most important web pages first. Relatedly, such ordering typically places high-frequency web pages (i.e., web pages that are often included in websites), such as “home,” “about,” and “contact” pages, at the top of the table, facilitating the automated destination path acquisition described below.

At step 220, destination paths may be entered for the web pages in the page mapping table. A destination path is the full or truncated URL of the web page in the new version of the website that corresponds to the web page at the source path listed on a line of the table. A blank entry for the destination path may indicate that the path for that web page has not changed in the new version of the website. In some embodiments, the owner may enter the desired destination paths manually via the interface module 135, and the web server 100 receives the destination paths and stores them in the page mapping table. FIG. 2 illustrates an embodiment wherein, in conjunction with or instead of the manual entry, the web server 100 may automatically attempt to acquire the destination path that corresponds to each source path. Automated acquisition may include, at step 225, identifying some or all web pages in the new version of the website by URL, such as by crawling the new version of the website or querying a database in which the website is stored. Automated acquisition may further include, at step 230, matching old web page file names to new web page file names. Such matching may include applying one or more direct comparisons and/or one or more heuristic comparisons of web page file names in the source path column to web page filenames in the new website. Direct comparisons may be used to identify the web pages with URLs that have not changed in the new version. That is, if a new web page file name is a direct match to an old web page file name, the web server 100 may assume the old web page is present in the new version of the website.

Failing a direct match, heuristic comparisons may identify common patterns in the source path and one or more new web page URLs. Heuristic searches may employ any suitable statistical probability model, such as Bayesian probability, for matching web pages, and may employ a confidence level as a threshold for determining whether a match is certainly found, is certainly not found, or should be confirmed by the owner or another user. Some non-limiting examples of heuristic matches include:
a new web page has the same file name as an old web page, but the website directory structure is changed so that the full URL is not the same; the web server 100 may store the new web page URL as the destination path for the old web page;
a new file naming convention for the new website places a common prefix on all old web page file names; the web server 100 determines that a substantial portion of a new web page file name matches an old web page file name and may store the new web page URL as the destination path for the old web page;
the web server 100 checks the old file name against a data store containing groups of commonly-used alternatives for high-frequency web page file names (e.g., the front page of a website may be named “home.html,” “index.html,” “page1.html,” “welcome.html,” etc.) and stores a new web page URL as the destination path if the new web page has a file name from the same group as the old web page;
the new website replaces the query string URLs (e.g. “http://mydomain.com/index.php?page=foo”) of the old website with “clean URL” structuring that does not use query strings (e.g. “http://mydomain.com/foo”), and the heuristic comparisons have access to a conversion table for eliminating the query strings;
the new website uses URL “slugs” as a method of SEO by providing relevant keywords directly in the URL (e.g., a page can be reached at the base URL “http://mydomain.com/724/” but the slug “woodwork-and-carpentry” is appended to the URL for SEO); when a slug is generated or modified, the web server 100 determines the appropriate base URL as the source path and sets the destination path as the base URL with the desired slug appended, so that any request that includes the base URL will be redirected to the URL including the proper slug.

Automated acquisition may further include, at step 235, performing content comparisons instead of or in addition to direct or heuristic file name comparisons. For example, where a heuristic comparison has identified more than one possible match of new web pages to an old web page, the content of the new web pages may be compared to the content of the old web page to a desired depth. “Depth” herein refers to the complexity of the content comparison. A comparison with low depth may involve comparing the text within the title tags of each web page and determining a percent match. In contrast, a comparison with high depth may involve determining whether any image files are present within both the old and a new web page, or comparing paragraph text within the bodies of the web pages to determine common word density or identically reused phrases. Statistical probability models and confidence levels can be used as above to determine whether a match is found. In another example, the content comparison of step 235 may be performed on directly-matched old and new web pages (i.e., an exact match to an old web page file name is present in the new website, per step 230) to determine whether content that is relevant to the SEO metrics of the old web page is present on the new web page of the same name. If the relevant content is no longer present, the web server 100 may determine whether the content was moved to a new page using the heuristic comparisons of step 230 and/or the content comparisons of step 235; the web server 100 may enter then URL of any matching new web page as the destination path and request confirmation of the destination path from the owner. In yet another example, the content comparison of step 235 may be performed for any old web page that could not be matched using file name matching.

At step 240, the web server 100 may present the page mapping table to the owner via the interface module 135. The page mapping table may be complete upon presentation, provided the web server 100 was able to automatically match each old web page to a new web page with a suitable level of confidence. Source or destination paths that do not meet the confidence level may be indicated to the owner for confirmation. Some or all of the data in the table may be editable by the owner. Additional indicators may direct the owner to enter destination paths for source paths that could not be matched.

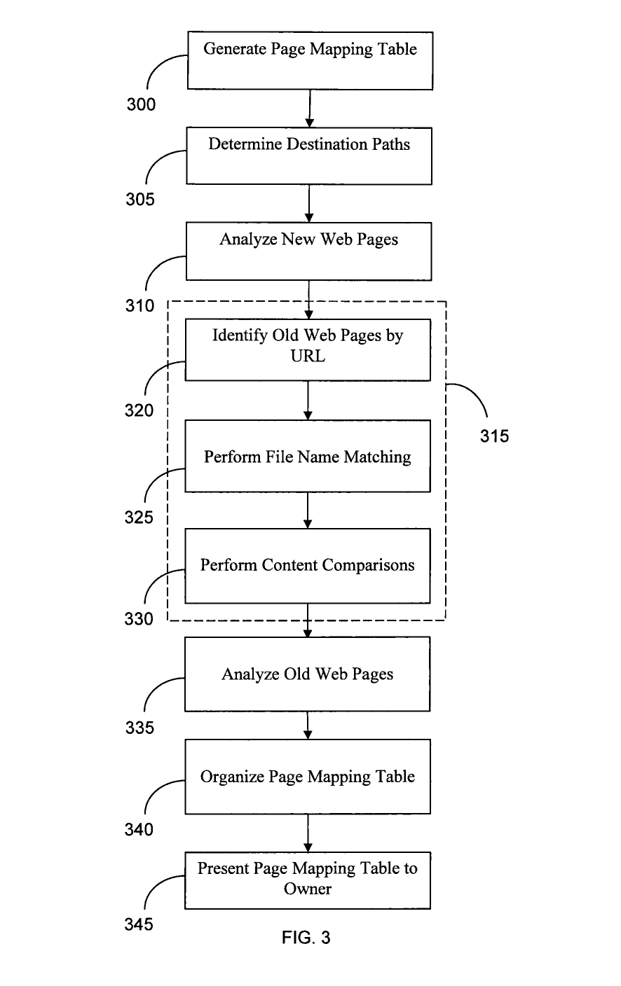

In other embodiments of completing the page mapping table, the steps as described in FIG. 2 may be performed in a different order. For example, the destination paths for the source paths in the page mapping table may be determined, as in step 220, before the table is organized in step 215. Furthermore, referring to FIG. 3, the page mapping table may be completed with reference to the destination paths instead of to the source paths. That is, at step 300 the page mapping table is generated as in step 200, but then at step 305 the destination paths are determined. The destination paths may be manually entered or acquired by the web server 100 using a website crawling methodology or a series of database queries. At step 310, the new web pages may be analyzed to extract useful page mapping information, such as web page titles, meta tag information, and the like.

At step 315, source paths may be entered for the old web pages that correspond to the new web pages. Entering the source paths may include, at step 320, identifying the old web pages by their URLs. The web server 100 may crawl the old version of the website using any suitable methodology to determine the source paths of the web pages. Additionally or alternatively, the web server 100 may access the index of one or more search engines 130 to identify the web pages of the old website that have been indexed by that search engine 130. Additionally or alternatively, such as if the old website is no longer online, the web server 100 may crawl an archived version of the website that may be available at archive.org (the Internet Wayback Machine), in GOOGLE Cache, or at another internet resource. The web server 100 may store the complete set of results (i.e., the URLs of all old web pages identified) for the subsequent matching steps 325, 330 and for further uses, or the web server 100 may perform the matching steps 325, 330 without storing all of the URLs. At step 325, the web server 100 may perform name matching between the URLs of the identified old web pages and the destination paths, as in step 230 above, and may store suitable matches as the source paths in the table. At step 330, the web server 100 may perform content comparisons as in step 235 above, and may store further matches as source paths in the table.

At step 335, the web server 100 may analyze the identified old web pages as in step 210 above in order to obtain the indexing status and/or SEO metrics for the old web pages. All of the identified old web pages may be analyzed, or only the old web pages that are entered into the page mapping table as source paths may be analyzed. At step 340, the completed page mapping table may be organized as in step 215 above. At step 345, the page mapping table may be presented to the owner via the interface module 135. In addition to the matched source and destination path entries, the page mapping table may be presented with the option to display old web pages that were not mapped to any new web pages. In particular, the page mapping table can include unmapped old web pages that have relatively valuable SEO metrics, such as a high GOOGLE Page Rank, so that the owner can retain a page mapping for those web pages. The unmapped old web pages may be displayed as source paths, with an indicator to the owner that a destination path should be entered for each unmapped web page.

While the owner can manipulate the page mapping table as needed, the web server 100 may use the completed or partially completed page mapping table to handle requests for the web pages at the source paths. In some embodiments, the web server 100 may handle such requests using a redirector page for each row of the page mapping table. A “redirector page” is a web page that has the source path as its URL and contains source code that either automatically forwards the visitor/requestor to the destination path, or contains an instruction to the visitor/requestor that the web page previously located at the source path has moved to the destination path. For example, a redirector page that automatically forwards the visitor may contain a meta refresh tag that redirects the visitor to the destination path after a predetermined time. When the web server 100 publishes the new website, it may concurrently publish redirector pages for each of the source paths in the page mapping table. The web server 100 may propagate changes to the page mapping table by publishing new or revised redirector pages when the changes are made.

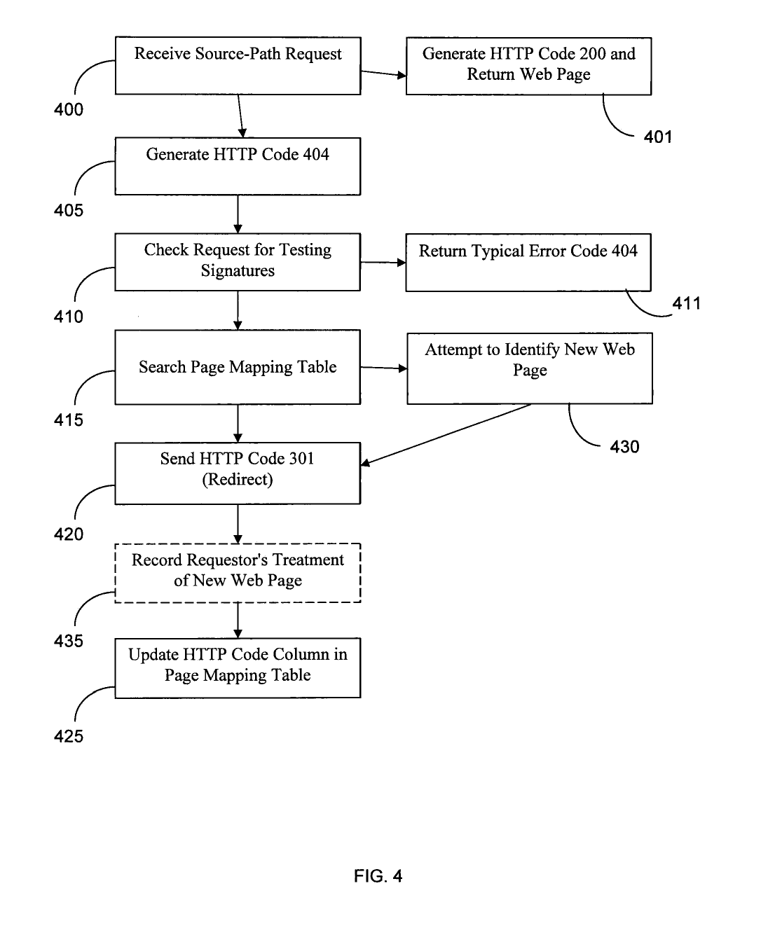

In other embodiments, the web server 100 may handle source-path requests using HTTP status codes. Referring to FIG. 4, the web server 100 first receives a request for a web page at a source path at step 400. If the source path still exists in the new website, at step 401 the web server 100 returns a HTTP code 200 “OK” along with the requested web page. If the source path does not exist, at step 405 a HTTP status code 404 “Page Not Found” error code is generated and the web server 100 is notified of the 404 error. It is known that some search engines 130 employ server requests that test the web server's 100 proper handling of code 404 errors. Therefore, at step 410, the web server 100 may check the source-path request for known testing signatures, such as a pattern in the requested URL or a particular User Agent identification. If the source-path request contains data that matches a known 404 test request, at step 411 the web server 100 returns a typical error code 404 response to the requestor.

If the request is a legitimate request for the old web page that resided at the source path, at step 415 the web server 100 may search the page mapping table for a destination path that corresponds to the source path. If a corresponding destination path is found, at step 420 the web server may send a HTTP status code 301 “Moved Permanently” to the requestor. Commonly known as the “301 redirect,” this status code can be interpreted by browsers and other user agents so that the user is automatically forwarded to the new URL provided in the status code, which may be the appropriate destination path from the page mapping table. Google and other search engines have indicated that the 301 redirect will retain most of the accumulated SERP prominence of the original (i.e., old) web page. At step 425, the web server 100 may update the “HTTP code” column for the source path to “301” if needed.

The web server 100 may fail to identify a destination path from the table, such as when the source path is not in the table or a destination path has not been associated with it. In some embodiments, if the web server 100 does not find a corresponding destination path at step 415, the web server 100 may return a standard code 404 error to the requestor. In other embodiments, at step 430 the web server 100 may perform one or more of the file name matching (step 230) and content comparisons (step 235) of the method of FIG. 2 to attempt to identify a suitable new web page for redirection. If a match is found, the web server 100 may store the URL of the matching new web page as the corresponding destination path and redirect the requestor to the destination path via a 301 redirect (step 420). For this and any other automatically-acquired destination path in the table, the web server 100 may record the requestor's treatment of the new web page at the destination path (step 435) as a measurement of the accuracy of the automatically-acquired destination path. That is, if the new web page is relevant to the old web page that the requestor intended to visit, the requestor may remain on the new web page for an extended period of time, click on hyperlinks within the new web page, or otherwise use the new web page. In contrast, if the stored destination path is not relevant, the requestor may quickly close the browser window or tab, perform a new search, or otherwise navigate away from the page before any measurable use is made of it. The web server 100 may retain the destination path if the usage data is favorable, or remove the destination path if the usage data is unfavorable. The usage data recording of step 435 may be optional, and may be skipped if the destination path was manually entered or otherwise confirmed as accurate.

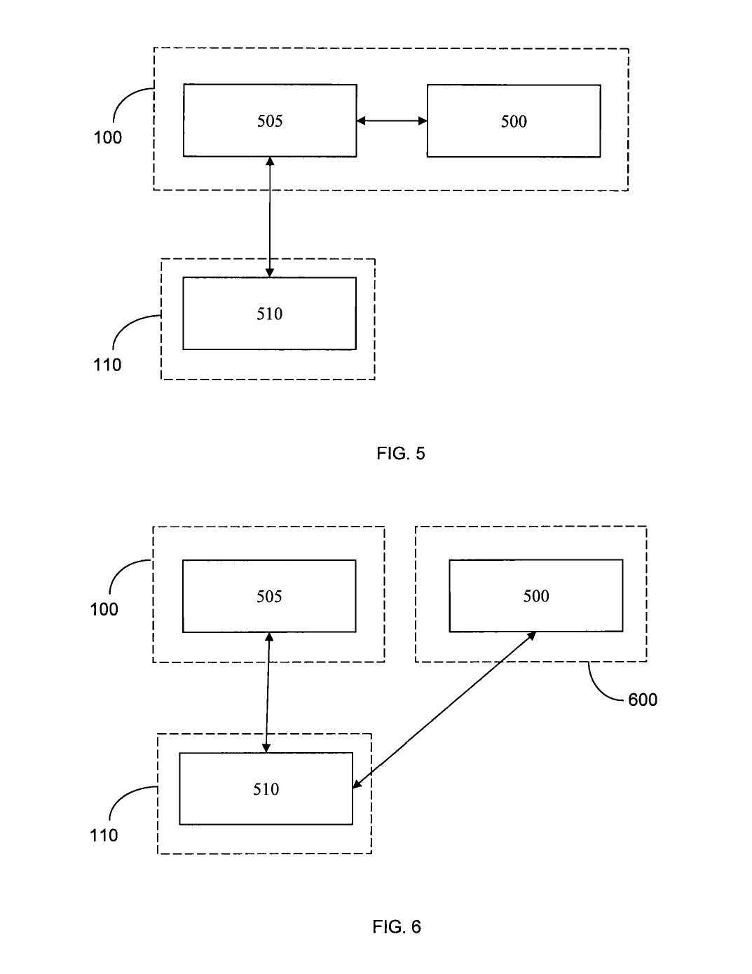

Referring to FIGS. 5 and 6, the web server 100 may use a page saver module 500 to handle source-path redirects with HTTP status codes. The page saver module 500 may reside together with the website 505 on the web server 100, or the page saver module 500 may reside on a separate redirect server 600. A browser 510 on the requesting device 110 may access the website 505 on the web server 100. In the embodiment of FIG. 5, when the browser 510 requests a web page at a URL that does not exist, the web server 100 may generate a 301 redirect that sends the browser 510 to a web page within the website 505 that is maintained by the page saver module 500. In the embodiment of FIG. 6, the 301 redirect generated by the web server 100 may send the browser 510 to a web page maintained by the page saver module 500 on a redirect server 600. In either embodiment, the 301 redirect may contain the URL that was requested by the browser 510. The page saver module 500 then attempts to resolve the URL in the 301 redirect, which may be the source path for an old web page, to a URL for a new page. In some embodiments, the page saver module 500 may store or have access to the page mapping table, and may search the page mapping table as in step 415 above. If the URL is not found in the page mapping table, or if the page saver module does not have access to the page mapping table, the page saver module 500 may attempt to identify the appropriate new web page as in step 430 above. If a match is found, the page saver module 500 may generate a new code 301 redirect containing the destination path and transmit the new 301 redirect to the browser 510. If a match is not found, the page saver module 500 may send a typical 404 Not Found error message to the browser 510.

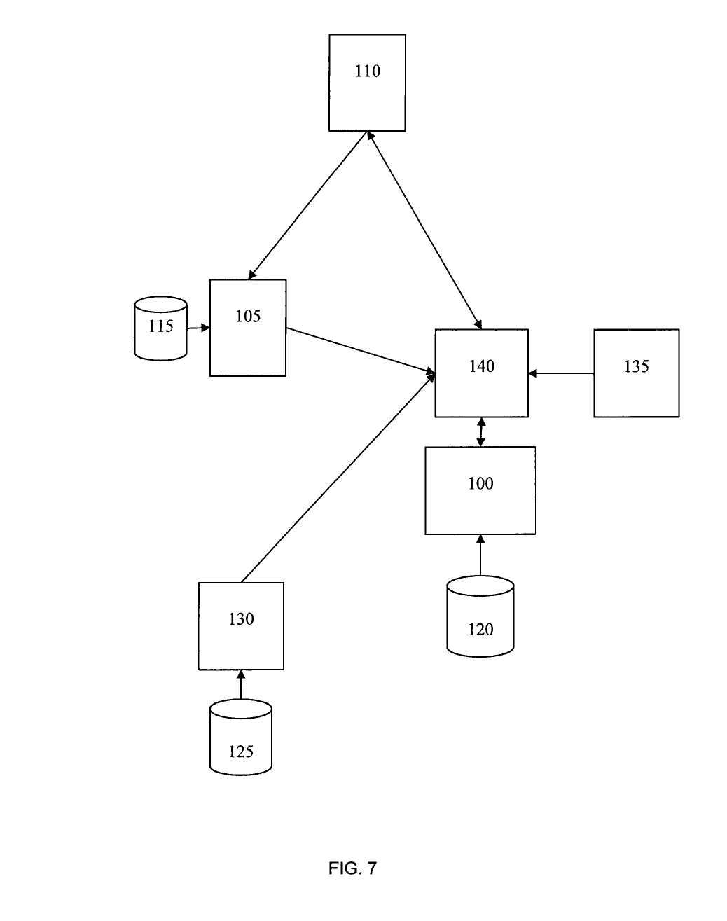

FIG. 7 illustrates an alternative embodiment of the system of FIG. 1, in which a proxy server 140 functions as an intermediate communication and request handling platform between the web server 100 and the devices that access the website. The proxy server 140 may be a physical or virtual server located remotely from, proximate, or within the web server 100. In this embodiment, the web server 100 and proxy server 140 are configured so that the web server 100 serves the website through the proxy server 140 (thus, the proxy server 140 may be considered a “reverse proxy”). That is, the DNS server 105 resolves the website's domain name to the proxy server 140 instead of the web server 100. Requesting devices 110 and search engines 130 therefore visit the proxy server 140, which is configured to pass URL requests through to the web server 100. The page mapping table may be built by the web server 100 or by the proxy server 140, for example using the method of FIG. 2, and then is stored on or by the proxy server 140. The interface module 135 thereafter may access the proxy server 135 to configure the page mapping table.

The proxy server 140 handles incoming URL requests as in FIG. 4. That is, the proxy server 140 first receives a request for a web page at a source path at step 400. If the source path still exists in the new website, at step 401 the proxy server 100 returns a HTTP code 200 along with the requested web page from the web server 100. If the source path does not exist, at step 405 a HTTP status code 404 error is generated and the proxy server 140 is notified of the 404 error. At step 410, the proxy server 140 may check the source-path request for known testing signatures, such as a pattern in the requested URL or a particular User Agent identification. If the source-path request contains data that matches a known 404 test request, at step 411 the proxy server 140 returns a typical error code 404 response to the requestor. At step 415 the proxy server 140 searches the page mapping table for a destination path that corresponds to the source path. If a corresponding destination path is found, at step 420 the proxy server 140 sends a HTTP code 301 to the requestor. If the proxy server 140 does not find a corresponding destination path, the proxy server 140 may return a standard code 404 error to the requestor, or may perform one or more of the file name matching (step 230) and content comparisons (step 235) of the method of FIG. 2 to attempt to identify a suitable new web page for redirection. If a match is found, the proxy server 140 may store the URL of the matching new web page as the corresponding destination path and redirect the requestor to the destination path via a 301 redirect (step 420).

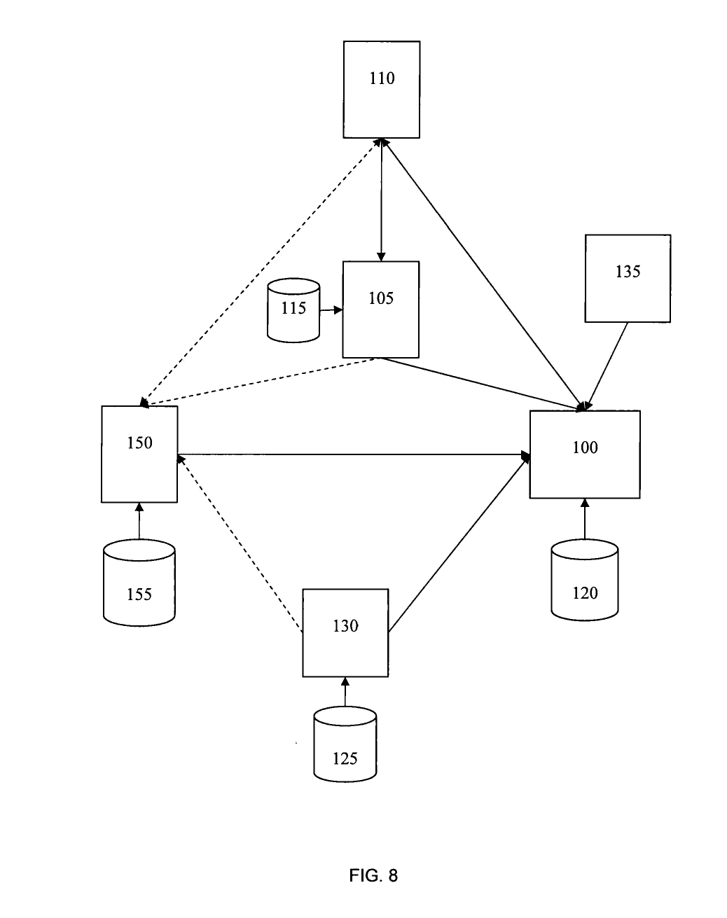

Referring to FIG. 8, the present system and methods may facilitate the transfer of the website from an old web server 150 to the web server 100. For example, the website may be transferred using any of the systems and/or methods described in co-pending U.S. patent application Ser. No. 14/043,656, by The Go Daddy Group, Inc., incorporated fully herein by reference. As part of the website transfer, the DNS records in the DNS record database 115 are updated so that the website's domain name resolves to an IP address on the web server 100 instead of an IP address on the old web server 150. In some embodiments, the website owner may transfer or authorize the transfer of website files (i.e., web pages and other web assets) from the old web server data store 155 to the website data store 120. During such transfer, the website owner may modify file names or content of web pages, and add or delete web pages. When such transfer is complete, the web server 100 may generate the page mapping table for the modified, added, and deleted web pages, and may then handle URL requests as described above.

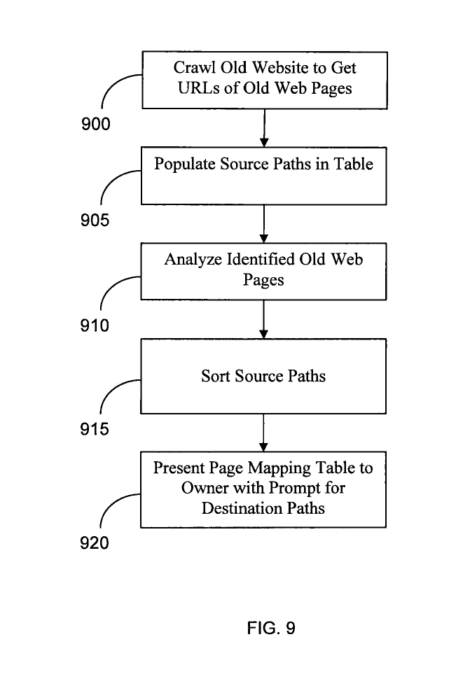

FIG. 9 illustrates another embodiment of completing the page mapping table in the system of FIG. 8. At step 900, the web server 100 may crawl the website while the website remains hosted at the old web server 150 (i.e., the “old website”). Crawling the old website returns a list of URLs for the web pages in the old website. At step 905, the web server 100 populates the source path column of the page mapping table with the URLs obtained at step 900. At step 910, the web server 100 analyzes the old web pages as in step 210 of FIG. 2, obtaining one or more SEO metrics for the old web pages. At step 915, the web server 100 may sort the source paths in descending order of prominence. Prominence may be determined by the SEO metrics obtained in step 910. For example, if the SEO metrics include the GOOGLE Page Rank of each old web page, the web server 100 may sort the table in descending Page Rank order, which places the most prominent pages at the top of the table. At step 920, the web server 100 may present the page mapping table to the owner via the interface module 135 and prompt the owner to enter a destination path for each of the source paths in the table. Alternatively to this manual entry, the web server 100 may match the source paths to an appropriate destination path using the automated methods described above.

Once the page mapping table is generated, the web server 100 may serve the website and handle source-path requests using the methods described above in order to protect the indexing status of the old web pages.

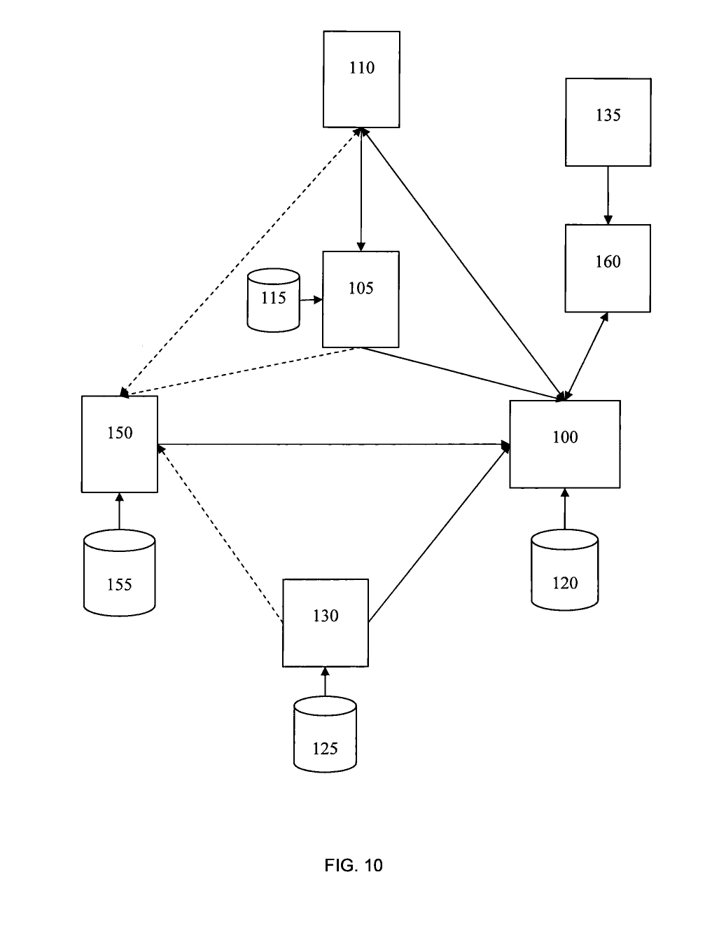

Similarly to the embodiment of FIG. 8, FIG. 10 illustrates a system in which an old website is transferred from the old web server 150 to the web server 100. The owner may use the interface module 135 to access a web design server 160 and create web pages for the new website to be hosted on the web server 100. The web design server 160 may store the created web pages in the website data store 120 or may transmit the web pages to the web server 100 for storage. In some embodiments, the web server 100 and web design server 160 may reside on the same physical server.

The web design server 160 may be configured to import web pages from the old website and present them to the owner during the web design process. The web design server 160 may itself crawl the old website to obtain the old web page data, or the web design server 160 may request the web server 100 or another server computer to crawl the old website. The web design server 160 may then present each of the old web pages to the owner. The owner may choose to keep or discard the old web page, and may edit the old web page and save the web page for use in the new website. The web design server 160 may be further configured to assist the owner in creating and saving completely new web pages. The web design process results in a new website that may contain all old web pages, all new web pages, or a mixture of old and new web pages.

The web server 100 may compile the page mapping table during the web design process or after it is complete. In an embodiment of the latter, the web server 100 may populate the source path and destination path columns of the page mapping table using any of the methods described above. In other embodiments, the web server 100 may populate the source path column of the page mapping table by crawling the old website as described above, and may transmit the incomplete table to the web design server 160. As each new web page is created, the web design server 160 may prompt the owner to associate the new web page with an old web page from the page mapping table. If the new web page is an imported old web page, the web design server 160 may prompt the owner to confirm that the old and new web pages are the same (and thus, SEO data should pass through from the old web page to the new web page). The web design server 160 may obtain the URL of the associated new pages and store them as destination paths in the table.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention has been described in terms of one or more preferred embodiments, and it should be appreciated that many equivalents, alternatives, variations, and modifications, aside from those expressly stated, are possible and within the scope of the invention.

We claim:

1. A method, comprising:
receiving, on a server computer and from a requestor in communication with the server computer over a computer network, a request for a first web page hosted at a source URL;
determining, by the server computer, a destination URL from one or more of the source URL and the first web page; and
redirecting, by the server computer, the requestor to the destination URL.

2. The method of claim 1, wherein determining the destination URL comprises:
accessing a page mapping table that associates web pages of a first website with web pages of a second website, the first website including the first web page and the second website including a second web page at the destination URL, the page mapping table including a column of source paths, of which the source URL is one, and a column of destination paths, of which the destination URL is one; and
searching the page mapping table for one or both of the source URL and a truncated URL consisting of a part of the source URL.

3. The method of claim 1, wherein determining the destination URL comprises matching the source URL or a truncated URL consisting of a part of the source URL to all or a portion of the destination URL.

4. The method of claim 1, wherein determining the destination URL comprises performing heuristic comparisons of the source URL or a truncated URL consisting of a part of the source URL to URLs of web pages in the second website until a match having a confidence level above a threshold identifies the destination URL.

5. The method of claim 1, further comprising:
generating a page mapping table that associates web pages of a first website with web pages of a second website, the first website including the first web page and the second website including a second web page at the destination URL, the page mapping table including a column of source paths and a column of destination paths, each source path comprising a URL of a web page in the first website, and each destination path comprising a URL of a web page in the second website;
determining, by the server computer, the source paths and entering them into the page mapping table;
identifying, by the server computer, the web pages of the second website by URL; and
for each source path:
determining if a web page of the second website should be associated with the source path; and
if a web page of the second website should be associated with the source path, storing the URL of the web page of the second website as the destination URL;
wherein the source URL is a first of the source paths and the destination URL is the first source path's associated destination path;
and wherein determining the destination URL comprises searching the page mapping table for one or both of the source URL and a truncated URL consisting of a part of the source URL.

6. The method of claim 5, wherein determining the source paths comprises crawling the first website.

7. The method of claim 5, wherein determining the source paths comprises retrieving a list of URLs for web pages of the first website that have been indexed by a search engine.

8. The method of claim 5, further comprising:
analyzing, by the server computer, the web pages hosted at the URLs of the source paths to determine a prominence of each of the web pages; and
sorting the source paths in the page mapping table by the prominence of the web pages hosted at the source paths.

9. The method of claim 1, wherein redirecting the requestor to the destination URL comprises transmitting a HTTP status code 301 redirect to the requestor.

10. A method, comprising:
obtaining, by a server computer, one or more source URLs each corresponding to one of a plurality of first web pages of a first website;
storing, by the server computer, one or more of the source URLs as source paths in a page mapping table that associates each of the source paths with a destination path;
for each source path:
determining if one of a plurality of second web pages should be associated with the source path; and
if one of the second web pages should be associated with the source path, storing the URL of the second web page as the destination path associated with the source path;
receiving, on the server computer and from a requestor, a request for one of the first web pages, the request comprising the source URL corresponding to the requested first web page;
determining, by the server computer, a destination URL by:
identifying the source path in which the source URL of the request is stored; and
retrieving, as the destination URL, the URL stored in the destination path associated with the identified source path; and
redirecting, by the server computer, the requestor to the destination URL.

11. The method of claim 10, wherein obtaining the one or more source URLs comprising crawling, by the server computer, the first website.

12. The method of claim 10, wherein obtaining the one or more source URLs comprises retrieving from a search engine a list of URLs that have been indexed by the search engine.

13. The method of claim 10, wherein redirecting the requestor to the destination URL comprises transmitting a HTTP status code 301 redirect to the requestor.

14. The method of claim 13, wherein redirecting the requestor to the destination URL further comprises:
receiving, at the server computer, a HTTP status code 404 “Not Found” error for the source URL of the request;
upon receipt of the HTTP status code 404 error, identifying in the page mapping table the destination URL in the destination path associated with the source path that contains the source URL; and
inserting the destination URL into the HTTP status code 301 redirect.

15. The method of claim 10, further comprising recording, by the server computer, the requestor's treatment of the second web page at the destination URL.

16. A system, comprising:
a processor configured to:
obtain a source URL for a first web page of a first website;
store the source URL as a source path in a page mapping table that associates each of a plurality of source paths with a destination path;
match the first web page to a second web page of a second website; and
store, in the destination path associated with the source path that contains the source URL, the URL of the second web page.

17. The system of claim 16, wherein the processor is further configured to:
receive, from a requestor in communication with the processor over a computer network, a request for the first web page, the request comprising the source URL corresponding to the requested first web page;
determine a destination URL by:
identifying the source path in which the source URL of the request is stored; and
retrieving, as the destination URL, the URL stored in the destination path associated with the identified source path; and
redirect the requestor to the destination URL.

18. The system of claim 16, wherein obtaining the source URL comprises crawling the first website.

19. The system of claim 18, wherein the first website is hosted on a first web server remote from the processor.

20. The system of claim 20, further comprising a second web server configured to host the second website.

21. The system of claim 16, further comprising a web server configured to host one or both of the first and second websites.

22. The system of claim 21, wherein the web server comprises the processor.
